(19) United States
(12) Patent Application Publication
(10) Pub. No.: US 2024/0317906 A1
(43) Pub. Date: Sep. 26, 2024

(54) PROCESS FOR THE PREPARATION OF VINYLAROMATIC POLYMERS

(71) Applicant: VERSALIS S.P.A., San Donato Milanese (MI) (IT)

(72) Inventors: Alessandro CASALINI, San Donato Milanese (MI) (IT); Aldo LONGO, Mantova (MN) (IT); Emilj SONCIN, Mantova (MN) (IT); Nicola FIOROTTO, Mantova (MN) (IT)

(21) Appl. No.: 18/575,083

(22) PCT Filed: Jun. 28, 2022
(86) PCT No.: PCT/IB2022/055998

§ 371 Date: Dec. 28, 2023

(30) Foreign Application Priority Data
Jul. 2, 2021 (IT) 102021000017519

(51) Int. Cl. C08F 12/08

(52) U.S. Cl. CPC C08F 12/08

(57) ABSTRACT

Continuous mass polymerisation process for the preparation of vinyl aromatic polymers includes:
continuously feeding at least one vinyl aromatic monomer and at least one radical initiator to a mixing device, obtaining a reaction mixture;
feeding the reaction mixture to a Continuous Stirred Tank Reactor (CSTR) and in liquid phase leaving the CSTR to at least one Plug Flow Reactor (PFR);
recycling, to the mixing device, a fraction of the reaction mixture in liquid phase leaving the at least one PFR, the fraction between 25% and 50% by mass with respect to total mass of reaction mixture in liquid phase leaving the at least one PFR;
feeding the remaining fraction of the reaction mixture in liquid phase leaving the at least one PFR, to a devolatilisation system; and
feeding the polymer leaving the devolatilisation system or additive system, to a granulation system and recovering the polymer.

### CROSS-REFERENCE TO RELATED APPLICATIONS

This application is a 35 U.S.C. § 371 National Stage patent application of PCT/IB2022/055998, filed on 28 Jun. 2022, which claims the benefit of Italian patent application 102021000017519, filed on 2 Jul. 2021, the disclosures of which are incorporated herein by reference in their entirety.

### TECHNICAL FIELD

The present disclosure relates to a process for the preparation of vinyl aromatic polymers.

More specifically, the present disclosure relates to a continuous mass polymerisation process for the preparation of vinyl aromatic polymers comprising continuously feeding at least one vinyl aromatic monomer and at least one radical initiator to a mixing device, obtaining a reaction mixture; feeding said reaction mixture to a Continuous Stirred Tank Reactor (CSTR); feeding the reaction mixture in liquid phase leaving said Continuous Stirred Tank Reactor (CSTR) to at least one Plug Flow Reactor (PFR): recycling, to said mixing device, a fraction of the reaction mixture in liquid phase leaving said at least one Plug Flow Reactor (PFR).

The vinyl aromatic polymers thus obtained can be advantageously used in the production of compact manufactured articles, foams and expandable beads.

The continuous radical mass polymerisation of vinyl aromatic monomers, such as styrene, is normally carried out in plants comprising a feeding section with possible purification of monomers and solvents, a reaction section comprising one or more reactors in series, a devolatilisation section of the polymer produced in order to remove residual monomers and solvents, and a finishing section. Each of these sections consists of one or more pieces of equipment.

### BACKGROUND

Processes for the preparation of vinyl aromatic monomers are known in the art.

For example, the American patent U.S. Pat. No. 3,903,202 relates to a process for the continuous mass polymerisation of polyalkenyl aromatic polymers comprising a dispersed grafted diene rubber phase, in which said continuous mass polymerisation is carried out, in the presence of a fraction of polymer in the reaction mixture as early as during the first reaction stage, in a plant comprising a Continuous Stirred Tank Reactor (CSTR) (Reactor 1) and a continuously stirred staged isobaric reactor (SIRS) (Reactor 2), evaporating, in series. The polymer fraction in the reaction mixture in the first reactor (Reactor 1) is in the range of 10% to 50%.

The American patent U.S. Pat. No. 4,777,210 relates to a polymerisation process for the production of High Impact Polystyrene (HIPS) in a continuous plant comprising two Continuous Stirred Tank Reactors (CSTRs) and at least one Plug Flow Reactor (PFR). The polymer fraction in the reaction mixture in the first reactor is less than 20%.

The American patent U.S. Pat. No. 2,769,804 relates to a continuous mass polymerisation process to obtain polymers from monovinyl aromatic monomers with a uniform molecular weights distribution curve (MWD) using a Continuous Stirred Tank Reactor (CSTR) or Plug Flow Reactor (PFR), in which part of the reaction mixture leaving the reactor is recycled into said reactor and a part is devolatilised to separate the unreacted mixture from the polymer produced and recycle it in feed to the reactor.

The American patent U.S. Pat. No. 3,821,330 relates to a continuous mass polymerisation process to obtain acrylic polymers using an adiabatic Plug Flow Reactor (PFR), in which at least 55% of the outgoing reaction mixture is recycled into feed.

The American patent U.S. Pat. No. 3,954,722 relates to a continuous polymerisation process, in mass or in solution, of unsaturated olefinic monomers using a Continuous Stirred Tank Reactor (CSTR) which, in order to obtain a greater homogeneity of the mixture reaction, uses a partial recycling of the reaction mixture inside the reactor with viscosity higher than 100 poise in the feed so as to increase the viscosity of the feed mixture, which would otherwise be lower than 10 poise. The mixture, consisting of unsaturated olefinic monomers, solvent, initiator, condensate of the Continuous Stirred Tank Reactor (CSTR) evaporating, condensate coming from the devolatilisation section of the polymer mixture discharged from the reactor and recycling reaction mixture of the reactor, is prepared in a special mixer which feeds said reactor.

The American patent U.S. Pat. No. 4,209,599 relates to a continuous mass polymerisation process for the production of vinyl polymers with feeding of a monomer mixture, in the presence of a polymerisation initiator, to at least one Plug Flow Reactor (PFR), with static mixing elements that convert the monomers for at least 75% in output and that recycle from 50% to 95% of the outgoing reaction mixture, in feeding to said Plug Flow Reactor (PFR). The recycling ratio (RR) between the flow rate of the recycled reaction mixture and that sent to the subsequent devolatilisation section therefore varies from 1 to 19 and the degree of inlet conversion varies between 37.5% and 71.3%. The plant in which the aforementioned process is carried out may include several Plug Flow Reactors (PFRs), each with recycling, in series.

The American patent U.S. Pat. No. 4,948,847 relates to a continuous mass polymerisation process of styrene with optional vinyl comonomers, comprising at least one tubular reactor with recycling and at least one tubular reactor without recycling placed in series, where the piston flow and the heat exchange with the wall inside each tubular reactor are favoured by static mixing elements. The fed monomer mixture contains 2% to 10% of solvent and 98% to 90% of monomers and an organic peroxide with a half-life of 10 hours between 75° C. and 130° C., which reacts for at least 70% in said at least one tubular reactor with recycling. Said tubular reactor, with or without recycling, can be a Sulzer-type tubular mixer, a Kenix-type static mixer, a Toray-type tubular mixer.

However, the above reported processes may have some drawbacks. For example, the processes in which a Continuous Stirred Tank Reactor (CSTR) is used, with or without recycling, allow for the production of homogeneous polymers, with a narrow molecular weights distribution curve (MWD), but do not allow for the efficient use, with complete reaction, of the polymerisation initiator. In fact, using a single Continuous Stirred Tank Reactor (CSTR), long residence times are required inside the reactor to reach a fraction of polymer in the reaction mixture higher than 60% and to make the radical initiator, such as a difunctional radical initiator, optionally fed to increase the reaction rate and the weight average molecular mass (M_{w}), react completely. Furthermore, using a Continuous Stirred Tank Reactor (CSTR), whilst operating under good mixing conditions, it is not possible to obtain a wide molecular weights distribution curve (MWD), suitable for applications in the field of expanded foams and expandable polymers in granular form.

In the case of processes that use a series of Continuous Stirred Tank Reactors (CSTRs), the possibility increases of obtaining a wide molecular weights distribution curve (MWD) and of making the radical initiator, such as a difunctional radical initiator, fed with the monomer mixture in the first Continuous Stirred Tank Reactor (CSTR) react completely but, with a fraction of polymer in the first reactor lower than 50%, a high quantity of cyclic oligomers is produced and, if the last Continuous Stirred Tank Reactor (CSTR) is evaporating, its management becomes difficult for polymer fractions higher than 70%, due to the high viscosity.

In the case of processes that use one or a series of Plug Flow Reactors (PFRs), operating with a good control of the reaction temperature, there is greater flexibility in the production of polymers with the desired molecular weights distribution curve (MWD), a high fraction of polymer leaving the reactor series, complete consumption of an optional initiator, such as a difunctional initiator, fed with the monomer mixture in the first Plug Flow Reactor (PFR) but, on the other hand, a high production of cyclic oligomers due to the high fraction of monomers in said first Plug Flow Reactor (PFR) fed with the reaction mixture.

In the case of processes that use one or a series of Plug Flow Reactors (PFRs) with the recycling of part of the reaction mixture from the last to the first Plug Flow Reactor (PFR), in order to obtain a high fraction of polymer entering the first Plug Flow Reactor (PFR), i.e., a fraction greater than 45%, a high recycling ratio (RR) of viscous polymer solutions is required due to the high polymer fraction in the recycled reaction mixture.

### SUMMARY

The Applicant has therefore set itself the problem of finding a process for the preparation of vinyl aromatic polymers capable of overcoming the above problems. Specifically, the Applicant has set itself the problem of finding a process for the preparation of vinyl aromatic polymers which allows for high productivity to be obtained with a low formation of oligomers and for the molecular weights distribution curve (MWD) thereof to be controlled, with reduced energy consumption and low equipment costs.

The Applicant has now found a new continuous mass polymerisation process for the preparation of vinyl aromatic polymers comprising continuously feeding at least one vinyl aromatic monomer and at least one radical initiator to a mixing device, thus obtaining a reaction mixture: feeding said reaction mixture to a Continuous Stirred Tank Reactor (CSTR): feeding the reaction mixture in liquid phase leaving said Continuous Stirred Tank Reactor (CSTR) to at least one Plug Flow Reactor (PFR): recycling, to said mixing device, a fraction of the reaction mixture in liquid phase leaving said at least one Plug Flow Reactor (PFR). Said process allows for high productivity with low formation of oligomers to be obtained and for the molecular weights distribution curve (MWD) thereof to be controlled, with reduced energy consumption and low equipment costs. The vinyl aromatic polymers thus obtained can be advantageously used in the production of compact manufactured articles, foams and expandable beads.

Therefore, the present disclosure provides a continuous mass polymerisation process for the preparation of vinyl aromatic polymers comprising:
continuously feeding at least one vinyl aromatic monomer and at least one radical initiator to a mixing device, obtaining a reaction mixture;
feeding said reaction mixture to a Continuous Stirred Tank Reactor (CSTR), said Continuous Stirred Tank Reactor (CSTR) containing a polymer fraction, in the reaction mixture in liquid phase, between 45% by mass and 60% by mass, preferably between 50% by mass and 58% by mass, with respect to the total mass of said reaction mixture in liquid phase;
feeding the reaction mixture in liquid phase leaving said Continuous Stirred Tank Reactor (CSTR) to at least one Plug Flow Reactor (PFR), said at least one Plug Flow Reactor (PFR) containing a polymer fraction, in the reaction mixture in liquid phase leaving said at least one Plug Flow Reactor (PFR), of at least 65% by mass, preferably between 70% by mass and 80% by mass, with respect to the total mass of said reaction mixture in liquid phase leaving said at least one Plug Flow Reactor (PFR);
recycling, to said mixing device, a fraction of the reaction mixture in liquid phase leaving said at least one Plug Flow Reactor (PFR), said fraction being between 25% by mass and 50% by mass, preferably between 25% by mass and 40% by mass, with respect to the total mass of the reaction mixture in the liquid phase leaving said at least one Plug Flow Reactor (PFR);
feeding the remaining fraction of the reaction mixture in the liquid phase leaving said at least one Plug Flow Reactor (PFR), to a devolatilisation system;
optionally, feeding the polymer leaving said devolatilisation system to an additive system;
feeding the polymer leaving said devolatilisation system or leaving said additive system, to a granulation system and recovering the polymer.

For the purpose of the present description and of the claims that follow, the definitions of the numerical ranges are always inclusive, unless otherwise specified.

For the purpose of the present description and of the claims that follow, the term “comprising” also includes the terms “which essentially consists of” or “which consists of”.

For the purpose of the present description and of the claims that follow, the term “Continuous Stirred Tank Reactor” (CSTR) refers to a mixing reactor which, in the steady state, has constant and equal mass flow rates in feed and outlet (without accumulation) and in which the temperature and composition of the reaction mixture in liquid phase is substantially the same throughout the liquid reaction volume.

For the purpose of the present description and of the claims that follow, the term “Plug Flow Reactor” (PFR), also referred to as a “Continuous Tubular Reactor”, refers to a reactor which, in the steady state, has constant and equal mass flow rates in feed and outlet (without accumulation) and in which the degree of advancement of the reaction mixture in liquid phase, from reactants to products, increases from inlet to outlet along the axis of the reactor and is radially substantially constant.

For the purpose of the present description and of the claims that follow, the term “reaction mixture in liquid phase leaving said at least one Plug Flow Reactor (PFR) refers, in the case in which there are several Plug Flow Reactors (PFRs) in series, to the reaction mixture in liquid phase leaving the last of said Plug Flow Reactors (PFRs).

In accordance with a preferred embodiment of the present disclosure, said vinyl aromatic monomer can be selected, for example, from the vinyl aromatic monomers having general formula (I):

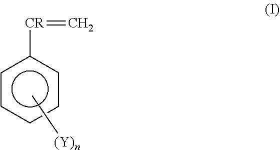

wherein R is a hydrogen atom or a methyl group, n is zero or 1, Y is a halogen atom such as, for example, chlorine, bromine, or a hydroxyl, or a halogenated alkyl group with 1 to 2 carbon atoms such as, for example, chloromethyl, bromomethyl, 1-bromoethyl, 1-chloroethyl, or an alkyl or alkoxy group with 1 to 2 carbon atoms.

In accordance with a preferred embodiment of the present disclosure, said vinyl aromatic monomer having general formula (I) can be selected, for example, from: styrene, α-methylstyrene, isomers of vinyltoluene, isomers of ethylstyrene, isomers of bromine styrene, isomers of chlorine styrene, isomers of methylbromostyrene, isomers of methylchlorostyrene, isomers of 1-bromoethylstyrene, isomers of 1-chloroethylstyrene, isomers of methoxystyrene, isomers of acetoxystyrene, isomers of hydroxystyrene, isomers of methylhydroxystyrene, or mixtures thereof: preferably is styrene.

In accordance with an embodiment of the present disclosure, at least one comonomer can be fed to said mixing device.

In accordance with a preferred embodiment of the present disclosure, said comonomer can be selected, for example, from vinyl monomers such as, for example, C₄-C₈ alkyl deriving esters from (meth)acrylic acid, glycidyl(meth)acrylate, or mixtures thereof; divinyl monomers such as, for example, isomers of divinylbenzene, esters of (meth)acrylic acid with diols such as, for example, ethylene glycol-dimethacrylate, butanediol-diacrylate, butanediol-dimethacrylate, hexanediol-diacrylate, hexanediol-dimethacrylate, or mixtures thereof; or mixtures thereof.

The vinyl aromatic polymers obtained in accordance with the above process are preferably:
polymers comprising 100% of vinyl aromatic monomers having general formula (I) by mass calculated with respect to the total mass of monomers in the reaction mixture, preferably 100% styrene by mass calculated with respect to the total mass of monomers in the reaction mixture (i.e., polystyrene);
copolymers comprising vinyl aromatic monomers having general formula (I) with at least 90% of styrene by mass calculated with respect to the total mass of monomers in the reaction mixture and not more than 10% by mass calculated with respect to the total mass of monomers in reaction mixture of vinyl comonomers such as, for example, styrene-alkylacrylate copolymers, styrene-alkyl methacrylate copolymers, styrene-glycidyl methacrylate copolymer;
copolymers comprising vinyl aromatic monomers having general formula (I) with at least 90% of styrene by mass calculated with respect to the total mass of monomers in the reaction mixture and no more than 10% by mass calculated with respect to the total mass of monomers in the reaction mixture of vinyl comonomers and divinyl monomers in quantities less than 500 parts per million in moles calculated over the total monomers present in the reaction mixture such as, for example, styrene-divinylbenzene, styrene-n-butylacrylate-divinyl-benzene, styrene-2-ethylhexylacrylate divinylbenzene, styrene-n-butylmethacrylate-divinylbenzene, styrene-2-ethylhexyl methacrylate-divinylbenzene, styrene-n-butylacrylate-ethyleneglycoldi-methacrylate, styrene-2-ethylhexylacry late-ethyleneglycoledimethacrylate, styrene-n-butylmethacrylate-ethyleneglycoledimethacrylate, styrene-2-ethylhexylmethacrylate-ethyleneglycoledimethacrylate.

It should be noted that, in the vinyl aromatic polymers obtained in accordance with the present disclosure, impurities such as, for example, substituted aromatic hydrocarbons such as, for example, ethylbenzene, xylene, cumene, n-propyl-benzene, and/or linear and branched paraffins with 5 or more carbon atoms, in an amount lower than 500 ppm by mass with respect to the total mass of the obtained vinyl aromatic polymer; and/or dimers or trimers, linear or cyclic (waxes) which are formed by reaction of the vinyl aromatic monomers parallel to the polymer, in an amount lower than 0.5% by mass, preferably lower than 0.25% by mass, with respect to the total mass of the vinyl aromatic polymer obtained.

In accordance with a preferred embodiment of the present disclosure, said radical initiator can be selected, for example, from radical initiators with a half-life of 1 hour, determined by DSC (Differential Scanning calorimetry) thermal analysis, in solvent monochlorobenzene, between 105° C. and 134° C., preferably difunctional radical initiators such as, for example: 1,1-di(tert-butylperoxy)-3,3,5-trimethylcyclohexane, 1,1-di(tert-amylperoxy)-cyclohexane, 1,1-di(tert-butilperoxy)-cyclohexane, tert-amylperoxy 2-ethylhexyl carbonate, tert-amylperoxyacetate, tert-butyl-peroxy-3,5,5-trimethylhexanoate, 2,2-di-tert-butyl-peroxybutane, tert-butylperoxy iso-propyl carbonate, tert-butylperoxy 2-ethylhexyl carbonate, tert-amyl peroxy benzoate, tert-butyl peroxyacetate, butyl-4,4-di(tert-butylperoxy)valerate, tert-butyl peroxy benzoate, di-tert-amyl peroxide, dicumyl peroxide, di(tert-butylperoxy-iso-propyl)benzene, 2,5-dimethyl-2,5-di(tert-butylperoxy)hexane, or mixtures thereof. 1,1-di(tert-butyl-peroxy)-cyclohexane is preferred.

The aforementioned radical initiators can be used individually or mixed together. Specifically, in order to obtain polymers with a high weight average molecular mass (M_{w}) difunctional radical initiators are preferred, used under conditions of residence time and reaction temperature such that, at the outlet from the last Plug Flow Reactor (PFR), they have reacted for at least 99.5%, preferably for 99.9%, more preferably for 100%, with respect to the quantity fed, in the reaction mixture: these, 1,1-di(tert-butylperoxy)-cyclohexane is preferred.

In accordance with a preferred embodiment of the present disclosure, said radical initiator can be present in the reaction mixture fed to said Continuous Stirred Tank Reactor (CSTR) at a concentration, calculated on the weight flow rate of the reaction mixture in liquid phase reaction entering the devolatilisation system, of between 0.2 millimoles and 2.5 millimoles of peroxide groups —[OO]— per kg of reaction mixture in liquid phase, preferably between 0.4 millimoles and 2.0 millimoles of peroxide groups —[OO]— per kg of reaction mixture in liquid phase, more preferably between 0.6 millimoles and 1.8 millimoles of peroxide groups —[OO]— per kg of reaction mixture in liquid phase.

It should be noted that the aforementioned continuous mass polymerisation process for the preparation of a vinyl aromatic polymer can be carried out in an open cycle as reported in the examples (pilot plant) for illustrative, but not limiting, purposes of the present disclosure, or in closed cycle in the case of an industrial plant.

In accordance with an embodiment of the present disclosure, at least one solvent can be fed to said mixing device, said solvent being preferably selected, for example, from optionally substituted aromatic hydrocarbons such as, for example, ethylbenzene, xylene, n-propylbenzene, cumene, ethyltoluene, in a quantity of between 0% by weight and 20% by weight, preferably between 2% by weight and 10% by weight, with respect to the total weight of the reaction mixture.

Said solvent can be fed to said mixing device as is, or through the recycling to said mixing device of a fraction of the reaction mixture in liquid phase leaving said at least one Plug Flow Reactor (PFR). In fact, with the exception of the first start-up phase of the closed-cycle plant (for example, in the case of an industrial plant), in the reaction mixture in the liquid phase that feeds the Continuous Stirred Tank Reactor (CSTR), there are non-polymerisable substances which, together, constitute a solvent given by the accumulation of impurities such as, for example, substituted aromatic hydrocarbons such as, for example, ethylbenzene, xylene, n-propylbenzene, ethyltoluene, cumene, linear and branched paraffins with 5 or more carbon atoms, dimers, trimers, linear and cyclic (waxes) which are formed by the reaction of vinyl aromatic monomers parallel to the polymerisation reaction. Said impurities, through the recycling to said mixing device, of a fraction of the reaction mixture in liquid phase leaving said at least one Plug Flow Reactor (PFR) constitute the solvent.

It should be noted that the amount of solvent fed to said mixing device can be adjusted both for the purpose of diluting the monomers and for the purpose of decreasing the reaction rate and the weight average molecular mass (M_{w}) of the vinyl aromatic polymer that is intended to be obtained through the aforementioned process, based on its reactivity as a chain transfer agent and moderator. As mentioned above, except for expensive separation operations, in the solvent recycled to said mixing device by recycling a fraction of the reaction mixture in liquid phase leaving the last Plug Flow Reactor (PFR) and, optionally, the fraction of the condensed mixture of the evaporates leaving the devolatilisation system, part of the oligomers, such as linear and cyclic dimers and trimers (waxes), are also present, deriving from the reaction of the vinyl aromatic monomers parallel to the polymerisation reaction. Linear oligomers have a significant effect both as chain transfer agents and as moderators of the reaction rate and their concentration must be reduced, especially if the intention is to obtain a high polymerisation rate and a high weight average molecular mass (M_{w}) of the vinyl aromatic polymer. The fraction of linear and cyclic dimers and trimers (waxes) present in the final polymer also contributes to the decrease in the glass transition temperature (Tg) and the part of cyclic dimers can decompose to styrene in a subsequent transformation process of the granules (extrusion and injection moulding) to produce compact products.

In the event that the intention is to decrease the weight average molecular mass (M_{w}) of all or part of the vinyl aromatic polymer in order to obtain a wide molecular weights distribution curve (MWD), chain transfer agents can be used.

The chain transfer agents with low and medium reactivity towards the growing vinyl aromatic radical chains allow for the regulation of the weight average molecular mass (M_{w}) of the vinyl aromatic polymer chains in a wide monomer conversion range and are preferably fed to the Continuous Stirred Tank Reactor (CSTR), as mentioned above, including through the recycling of a fraction of the reaction mixture in liquid phase leaving the last Plug Flow Reactor (PFR) and, optionally, of the fraction of the condensed mixture of the evaporates leaving the devolatilisation system, to said mixing device.

The chain transfer agents with high reactivity towards the growing vinyl aromatic radical chains are used, especially in the event that the intention is to obtain a vinyl aromatic polymer with a wide molecular weights distribution curve (MWD) and are preferably fed to the Plug Flow Reactor (PFR), or the series of Plug Flow Reactors (PFRs), operating under conditions of residence time and reaction temperature such that they react in quantities greater than 99.9% with respect to the quantity fed and are therefore present in quantities of less than 0.1% with respect to the quantity fed or even absent, both in the fraction of the reaction mixture in liquid phase leaving the last Plug Flow Reactor (PFR) and recycled to the mixing device, and in the fraction of the reaction mixture in the liquid phase fed to the devolatilisation system.

According to an embodiment of the present disclosure, to said Continuous Stirred Tank Reactor (CSTR), or to said at least one Plug Flow Reactor (PFR), can be fed at least one chain transfer agent.

In accordance with an embodiment of the present disclosure, said chain transfer agents can be selected, for example, from: low reactivity chain transfer agents such as, for example, 2,4-diphenyl-4-methyl-1-pentene (dimer of α-methylstyrene), polyunsaturated organic substances of the hydrocarbon type such as, for example, vegetable oils, squalene, farnesene, limonene, terpinolene, or mixtures thereof: medium reactivity chain transfer agents such as, for example, tertiary mercaptans with 4 to 12 carbon atoms such as, for example, tert-butyl mercaptan, tert-dodecyl mercaptan, or mixtures thereof: highly reactive chain transfer agents such as, for example, primary mercaptans with 4 to 12 carbon atoms such as, for example, n-butyl mercaptan, n-dodecyl mercaptan, or mixtures thereof.

In the event that the intention is to decrease the weight average molecular mass (M_{w}) of all or part of the vinyl aromatic polymer, preferred chain transfer agents are tert-dodecyl mercaptan, n-dodecyl mercaptan. Specifically:
tert-dodecyl mercaptan is preferably fed to the Continuous Stirred Tank Reactor (CSTR) at a concentration of between 0.005 parts by weight and 1 part by weight, per 100 parts of the reaction mixture in the liquid phase, said concentration being calculated on the weight flow of the reaction mixture in liquid phase leaving the Continuous Stirred Tank Reactor (CSTR);
n-dodecyl mercaptan is preferably fed to the Plug Flow Reactor (PFR) at a concentration of between 0.01 parts by weight and 1 part by weight, per 100 parts of the reaction mixture in liquid phase, said concentration being calculated on the weight flow rate of the reaction mixture in liquid phase leaving the last Plug Flow Reactor (PFR).

In accordance with a preferred embodiment of the present disclosure, in said Continuous Stirred Tank Reactor (CSTR), the reaction temperature can be between 120° C. and 140° C., preferably between 122° C. and 135° C.

In accordance with a preferred embodiment of the present disclosure, in said at least one Plug Flow Reactor (PFR) the reaction temperature can be between 130° C. and 175° C., preferably between 135° C. and 170° C.

The present disclosure allows for the obtaining of vinyl aromatic polymers with a polydispersity index given by the ratio between the weight average molecular mass (M_{w}) and the numerical average molecular mass (Mn) (M_{w}/Mn) from 2 to 10, by adjusting the reaction temperature in the Continuous Stirred Tank Reactor (CSTR) and in the Plug Flow Reactor (PFR) or in the series of Plug Flow Reactors (PFRs), the concentration of radical initiator, the concentration of comonomers optionally present in the feeding to the mixing device and to the Continuous Stirred Tank Reactor (CSTR), the feeding of the chain transfer agent to the mixing device or between the Continuous Stirred Tank Reactor (CSTR) and the Plug Flow Reactor (PFR) or in the series of reactors with Plug Flow Reactor (PFR) with optional complete reaction of said chain transfer agent in the event that it is highly reactive, at the outlet from the last Plug Flow Reactor (PFR), the feeding of the condensed mixture of the evaporates leaving the devolatilisation system to the mixing device and to the Continuous Stirred Tank Reactor (CSTR) and between the Continuous Stirred Tank Reactor (CSTR) and the Plug Flow Reactor (PFR) or the series of Plug Flow Reactors (PFRs) containing solvents coming from the devolatilisation system and, optionally, from the evaporation of the reaction mixture in said two reactors.

It is also easy to regulate the glass transition temperature (Tg) of vinyl aromatic polymers by feeding, to the mixing device and to the Continuous Stirred Tank Reactor (CSTR), comonomers that lower it, such as, for example, n-butylacrylate, 2-ethylhexylacrylate, or comonomers that raise it such as, for example, α-methylstyrene, allowing for an improvement in processability, especially for the production of expandable granules as described, for instance, in European patents EP 3056534 and EP 1485429.

For the purpose of the present disclosure, a plant for the continuous mass polymerization of vinyl aromatic polymers can be advantageously used, comprising:
a feeding section comprising at least one mixing device such as, for example, a static or dynamic mixer, at least one feeding line to the Continuous Stirred Tank Reactor (CSTR), at least one line for the recycling of a fraction of the reaction mixture in liquid phase leaving the last Plug Flow Reactor (PFR) of the reaction section to said mixing device and, optionally,
   a purification section of the monomers from inhibitors, oxygen and other unwanted impurities that may optionally be present;
   a section for thermostating the reaction mixture in feeding to the Continuous Stirred Tank Reactor (CSTR);
a reaction section comprising a Continuous Stirred Tank Reactor (CSTR), with temperature control of the reaction mixture, said control being preferably carried out by regulating the feeding temperature of said reaction mixture, by evaporation of part of said reaction mixture and by the regulation of the wall temperature of said Continuous Stirred Tank Reactor (CSTR) thanks to the presence of a thermostatic jacket, said Continuous Stirred Tank Reactor (CSTR) being provided with an adjustable level of the liquid phase and a suitable stirring system to allow for both a uniform temperature and the compositional homogeneity of the reaction mixture in the liquid phase and at least one Plug Flow Reactor (PFR) in series, preferably not evaporating, and with at least two thermostating zones or, in the event that one evaporating Plug Flow Reactor (PFR) is used, only one thermostating zone;
mixing systems for the optional addition of a chain transfer agent and condensed monomeric mixtures leaving as vapours from the devolatilisation section and optionally from the aforementioned reactors, if evaporating, or part of these, on the feed line to the Continuous Stirred Tank Reactor (CSTR), on the inlet line to the Plug Flow Reactor (PFR) in series and, optionally, at the inlet of each Plug Flow Reactor (PFR) subsequent to the first;
a devolatilisation section in which the polymer is separated from solvents and non-polymerized monomers;
a finishing section.

Optionally, based on the chemical-physical characteristics of the type of additive, at the inlet and/or outlet of said devolatilisation section, which can be of any type known in the art, there may be a feeding and mixing system for the additivation of antioxidants, plasticisers, release agents, heat-retardants, flame retardants, blowing agents, antistatic agents, dyes, stabilisers, that are suitable and different according to the applications of the vinyl aromatic polymer obtained.

The aforementioned finishing section can be of any type known in the art, suitable for the production of granules, expanded sheets and expandable granules.

### DETAILED DESCRIPTION OF THE DISCLOSURE

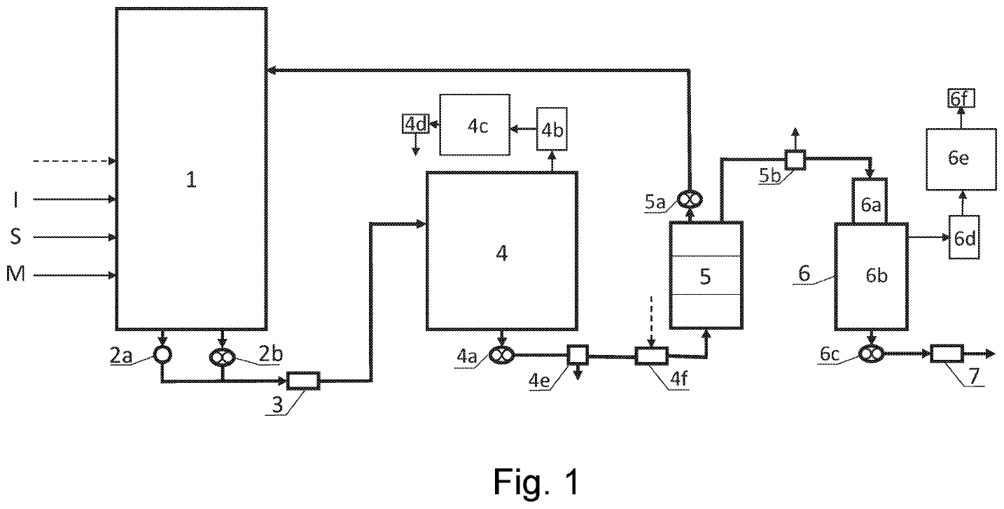

The present disclosure will now be described in greater detail through an embodiment with reference to FIG. 1 shown below.

FIG. 1 outlines an embodiment of the pilot plant used in the examples below (polymerisation conducted in an open cycle). Specifically, FIG. 1 shows a plant comprising: a mixing device (for example, a dynamic mixer) (1) fed with one or more monomers (M) (e.g., styrene), solvent (S) (e.g., ethylbenzene), polymerisation initiator (preferably difunctional, e.g., 1,1-di-tert-butylperoxy cyclohexane at 50% by mass in mineral oil) (I) and any other additives and reagents (specified in FIG. 1 by the dashed arrow), a pump with back pressure valve (2a), a gear pump (2b), a flow meter (3) of the reaction mixture in delivery to said pumps with back pressure valve (2a) for low viscosity liquids (used in the Examples 1, 2, 4 and 5, below reported where recycling is not present) and gear pump (2b) for viscous liquids (used in Examples 3, 6 and 7, below reported where recycling is present), said flow meter (3) connected to the jacketed evaporating Continuous Stirred Tank Reactor (CSTR) (4), equipped with a thermostating valve (not shown in FIG. 1) of the water temperature adjustable according to the internal temperature of the reaction mixture, stirred with a double belt stirrer for viscous mixtures (not shown in FIG. 1), a level meter for pressure difference (not shown in FIG. 1), a discharge nozzle on the bottom (not shown in FIG. 1) connected to a gear pump (4a) which feeds the reaction mixture to the Plug Flow Reactor (PFR) (5) and a nozzle on the lid (not shown in FIG. 1) connected to a condenser (4b), in turn connected to a tank for liquid collection (4c) connected to an outlet flow meter (4d). By means of a sampling valve (4e) placed between the gear pump (4a) and the Plug Flow Reactor (PFR) (5), samples of the reaction mixture in liquid phase can be taken at the outlet from the Continuous Stirred Tank Reactor (CSTR) (4) in order to determine its composition. By means of the mixer (4f) placed between the Continuous Stirred Tank Reactor (CSTR) (4) and the Plug Flow Reactor (PFR) (5) after the sampling valve (4e), liquids (for example, solvent, chain transfer agents) can be fed to the reaction mixture in liquid phase leaving the Continuous Stirred Tank Reactor (CSTR) (4) (dashed line in FIG. 1).

Said Plug Flow Reactor (PFR) (5) is divided into three thermostating zones, with pipes containing circulating oil to regulate the separate reaction temperature in the three zones (not shown in FIG. 1), with an inlet for the reaction mixture leaving the Continuous Stirred Tank Reactor (CSTR) (4) and two outlets, one of which with a gear pump (5a) which feeds the mixing device (1) and one that feeds the devolatilisation system (6) with heat exchanger (6a) and vacuum container (6b) to separate the polymer leaving the Plug Flow Reactor (PFR) (5) from the non-polymerized components of the reaction mixture in the liquid phase. By means of a sampling valve (5b) placed between the Plug Flow Reactor (PFR) (5) and the heat exchanger (6a), samples of the reaction mixture in liquid phase can be taken at the outlet from the Plug Flow Reactor (PFR) (5) in order to determine the composition. The polymer obtained comes out of the bottom of said container under vacuum (6b) and is sent by means of a gear pump (6c) to a granulation system (7). The solvent vapours and unreacted monomers present in the vacuum container (6b) are sent to the condenser (6d) which is, in turn, connected to a liquid collection tank (6e) and to a sampling valve (6f) from which liquid samples are taken in order to determine the composition.

In order to better understand the present disclosure and to put it into practice, some illustrative and non-limiting examples hereof are shown below.

### Examples 1-5 (Comparative) and 6-7 (Disclosure)

The examples were carried out in a pilot, open cycle plant, in accordance with FIG. 1.

For this purpose, fed continuously at 70° C. to a 1000-litre-capacity jacketed dynamic mixer (1), equipped with a stirrer, temperature control and level control (not shown in FIG. 1), were styrene (99.8% purity-Versalis) and ethylbenzene (Versalis) in a ratio of 94/6 by mass, 1,1-di(tert-butylperoxy)-cyclohexane at 50% by mass in mineral oil (Akzo Nobel) (Examples 4-7, in the quantities shown in Table 1) and part of the reaction mixture in liquid phase leaving the Plug Flow Reactor (PFR) (5) (Examples 3, 6-7, in Table 1).

The reaction mixture obtained was sent through the pump with back pressure valve (2a) for low viscosity liquids (Examples 1, 2, 4 and 5, in which there is no recycling as shown in Table 1) or through the pump with gears (2b) for viscous liquids (used in Examples 3, 6 and 7, in which there is recycling as reported in Table 1) and a flow meter (3) to a jacketed evaporating Continuous Stirred Tank Reactor (CSTR) (4) of 300 litres at 100% level (224 kg of reaction mixture in the liquid phase, equal to 75% of filling), fitted with a thermostating valve (not shown in FIG. 1) of the temperature of the circulating water in the jacket adjustable based on the internal temperature of the reaction mixture, stirred with a double belt stirrer for viscous mixtures (not shown in FIG. 1), of a level meter for pressure difference (not shown in FIG. 1), of nozzle bottom drain (not shown in FIG. 1) connected to a gear pump (4a) which feeds the reaction mixture to the vertical, agitated, 120-litre Plug Flow Reactor (PFR) (5), divided into three thermostating zones, with pipes containing circulating oil to regulate the different reaction temperature in the three zones and a nozzle on the lid (not shown in FIG. 1) connected to a condenser (4b), in turn connected to a liquid collection tank (4c) connected to an outlet flow meter (4d). By means of a sampling valve (4e) placed between the gear pump (4a) and the Plug Flow Reactor (PFR) (5), samples of the reaction mixture were taken in the liquid phase at the outlet from the Continuous Stirred Tank Reactor (CSTR) (4) in order to determine its composition.

In Examples 3 and 6-7, a fraction of the reaction mixture in liquid phase leaving the Plug Flow Reactor (PFR) (5) (33.3%) was recycled through the pump gears (5a) to the dynamic mixer (1) operating at a recycling ratio (RR) shown in Table 1.

The remaining fraction of the reaction mixture leaving the Plug Flow Reactor (PFR) (5), was fed to the devolatilisation system (6), where it was heated to a temperature of 250° C. in the heat exchanger (6a) and maintained at a residual pressure of 11 mmHg in the vacuum container (6b), in order to remove the solvent and unreacted monomers.

The polymer leaving the devolatilisation system, with an approximately constant flow rate for all the examples shown in Table 1, equal to approximately 60.7 kg/h, was sent to the granulator (7).

The determination of the weight average molecular mass (M_{w}) of the polymer present in the reaction mixture withdrawn through the sampling valve (5b), was carried out using a GPC (Gel Permeation Chromatography) equipment consisting of:
Waters Alliance E2695 pump-injector module equipped with a degasser;
Waters oven with pre-column and 4 Phenogel (Phenomenex) columns, dimensions 300×7.8 mm, particle size 5μ, porosity 106 Å, 105 Å, 104 Å, 103 Å;
RI Waters 410 refractive index detector.

The operating conditions used were as follows:
solvent: tetrahydrofuran (THF) (Merck);
column temperature: 30° C.;
flow: 1 ml/min;
internal standard: toluene;
injection volume: 200 microlitres.

(Polydispersed) samples were injected at a concentration of 1 mg/ml.

The universal calibration curve was constructed by injecting 20 monodispersed polystyrene standards, with a molecular mass (Mₚ) of between 2170 Da and 4340000 Da, recording the intrinsic viscosity and elution volume for each molecular mass.

Data acquisition and processing was carried out through Empower2 software (Waters).

Table 1 shows the average molecular mass by mass (M_{w}) of the obtained polymers.

The quantity of polymer in the reaction mixture withdrawn through the sampling valve (4e) and through the sampling valve (5b), was determined gravimetrically by dissolving 0.5 g of reaction mixture (weighed with a balance with accuracy to the thousandth gram) in 20 ml of chloroform (Carlo Erba) and precipitating the solution thus obtained by adding it drop by drop into a glass containing 150 ml of ethanol (Carlo Erba), under stirring. At the end, the whole was left to rest until the liquid remained clear with the polymer precipitated on the bottom. Subsequently, the polymer was recovered by filtration on a VitraPOR® 20304 (Robu Glass Filter) filtering crucible filter and dried in an oven at 110° C. under vacuum to constant weight.

The quantity of linear and cyclic dimers and trimers (waxes) of the styrene present in the reaction mixture withdrawn through the sampling valve (5b) was determined by gas-chromatography by operating as follows:
gas chromatograph (Trace 1300) equipped with “on-column” injector, autosampler (Triplus) and electronic carrier flow control;
chromatography column with methyl silicone phase (Agilent HP1) with a length of 25 m, thickness of stationary phase of 0.52 mm and a diameter of 0.32 mm;
Flame Ionization Detector (FID);
chromatographic acquisition software.

The gas chromatograph was set up as follows:
carrier: hydrogen;
flow ramp: 2 ml/min for 1 min, 0.2 ml/min up to 4.2 ml/min, then it was kept constant at 4.2 ml/min until the end of the stroke;
detector temperature: 330° C.;
temperature programme: 60° C. up to 160° C. at 40° C./min, isotherm at 160° C. of 5 min, ramp of 8° C./min up to 325° C., isotherm of 5 min.

The polymer sample to be analysed was prepared by dissolving 0.5 g of sample in 3 ml of dichloromethane (Merck) containing 50 ppm of n-hexadecane (Merck) as internal standard and subsequent precipitation of the polymer with 8 ml of ethanol (Carlo Erba): 1 ml of the liquid obtained from said precipitation was injected into the aforementioned gas chromatograph. Response factor 1 was attributed to all oligomers: the values obtained are shown in Table 1.

Table 1 also shows the reaction conditions used.

TABLE 1

| | 1 | 2 | 3 | 4 | 5 | 6 | 7 |
|---|---|---|---|---|---|---|---|
| EXAMPLE | (comparative) | (comparative) | (comparative) | (comparative) | (comparative) | (disclosure) | (disclosure) |
| Qᵢₙ CSTR | 115 | 110 | 135 | 114 | 117 | 148 | 151 |
| (kg/h) | | | | | | | |
| Q_{c} CSTR | 28.0 | 29.1 | 13.6 | 33.1 | 26.4 | 26.8 | 29.2 |
| (kg/h) | | | | | | | |
| F. init. | 0 | 0 | 0 | 96 | 171 | 135 | 152 |
| (g/g × 10⁶) | | | | | | | |
| T CSTR | 141 | 142 | 144 | 135 | 128 | 125 | 124 |
| (° C.) | | | | | | | |
| F. Polₒᵤₜ CSTR | 43 | 46 | 54 | 47 | 47 | 55 | 56 |
| (%) | | | | | | | |
| T PFR (° C.) | 150-161 | 152-166 | 157-171 | 150-170 | 147-170 | 143-170 | 139-166 |
| Qₒᵤₜ PFR | 87 | 81 | 121 | 81 | 81 | 121 | 121 |
| (kg/h) | | | | | | | |
| F. Polₒᵤₜ PFR | 70 | 75 | 75 | 75 | 75 | 75 | 75 |
| (%) | | | | | | | |
| RR | 0 | 0 | 0.5 | 0 | 0 | 0.5 | 0.5 |
| Q_{wax} | 655 | 643 | 617 | 454 | 329 | 235 | 182 |
| (g/h) | | | | | | | |
| Q_{wax}/Qₚₒₗ | 10.8 | 10.6 | 10.2 | 7.5 | 5.4 | 3.9 | 3.0 |
| (g/kg) | | | | | | | |
| M_{w} | 259 | 252 | 236 | 271 | 288 | 291 | 300 |
| (kDa) | | | | | | | |

Qᵢₙ CSTR: total flow rate of the reaction mixture fed to the CSTR (4) determined by the flow meter (3) (kg/h);
Q_{c} CSTR: flow rate of condensed vapour leaving the CSTR (4) determined at steady state by measuring the level difference in one hour of the liquid collection tank (4c) and the density of the liquid collected on a sample taken from (4d) (kg/h);
F. init.: mass fraction of radical initiator [1,1-di(tert-butylperoxy)-cyclohexane at 50% in mineral oil] calculated on the total flow rate of the reaction mixture fed to the CSTR (4) [g/(g×10⁶)];
T CSTR: temperature of the reaction mixture and of the CSTR jacket (4) (° C.);
F. Polₒᵤₜ CSTR: fraction of polymer in the reaction mixture in liquid phase leaving the CSTR (4) (%), determined by gravimetric analysis of reaction mixture samples taken through the sampling valve (4e);
T PFR: range of increasing temperatures of the reaction mixture in liquid phase in the three zones of the PFR (5) (° C.);
Qₒᵤₜ PFR: total flow rate of the reaction mixture in liquid phase leaving the PFR (5), equal to that entering it and the liquid phase leaving the CSTR (4), calculated on the basis of the flow rate measured by the flow meter flow rate (3) minus the flow rate of condensed vapours in the liquid collection tank (4c) (kg/h);
F. Polₒᵤₜ PFR: fraction of polymer in the reaction mixture in liquid phase leaving the PFR (5) (%), determined both by gravimetric analysis of reaction mixture samples taken through the sampling valve (5b) and calculated based on the quantity of polymer leaving the granulator (7) and the flow rate of condensed vapours, measured by level difference in one hour, of the liquid collection tank (6e) and the density of the liquid collected on a sample taken from the sampling valve (6f);
RR: recycling ratio between the flow rate of the reaction mixture in liquid phase leaving the PFR (5) and recycled to the dynamic mixer (1) by means of the gear pump (5a) and the flow rate of the reaction mixture leaving the PFR and sent to the devolatilisation system (6), calculated both on the basis of the ratio of the revolutions of the gear pumps (4a) and (5a) and on the basis of the flow rates Qₒᵤₜ PFR and of granule leaving the granulator (7);
Q_{wax}: flow rate of linear and cyclic dimers and trimers (waxes) formed in reaction and measured in the reaction mixture in liquid phase sampled by the sampling valve (5b) feeding to the devolatilisation system (6), (g/h);
Q_{wax}/Qₚₒₗ: specific quantity, per kg of polymer fed to the devolatilisation system (6), of linear and cyclic dimers and trimers (waxes) produced in reaction, (g/kg);
M_{w}: average molecular mass by mass of the polymer leaving the PFR (5) on a sample taken from the sampling valve (5b), (kDa).
   From the data shown in Table 1, the following can be deduced:
in Example 1 (comparative), in which the radical initiator was not fed and there was no recycling from the PFR (5) to the dynamic mixer (1), a high wax formation (655 g/h with a Q_{wax}/Qₚₒₗ ratio of 10.8 g/kg) and a weight average molecular mass value (M_{w}) of 259 kDa;
in Example 2 (comparative), in which the radical initiator was not fed and there was no recycling from the PFR (5) to the dynamic mixer (1) as in Example 1 (comparative), the flow rate to the CSTR (4) was lower and the reaction temperatures in CSTR (4) and PFR (5) were higher, an increase in the fraction of polymer leaving the CSTR (4) and PFR (5) was obtained, with a modest decrease in the waxes produced (643 g/h with a Q_{wax}/Qₚₒₗ ratio of 10.6 g/kg), but with a decrease in the weight average molecular mass (M_{w}) of 252 kDa;
in Example 3 (comparative), in which the radical initiator was not fed as in Example 1 (comparative) but a recycling equal to 33.3% of the reaction mixture leaving the PFR (5) was inserted, in feeding to the dynamic mixer (1) (RR=0.5), a modest reduction in the formation of waxes produced was obtained (617 g/h with a Q_{wax}/Qₚₒₗ of 10.2 g/kg) and with a further decrease in the weight average molecular mass (M_{w}) which is equal to 236 kDa;
in Example 4 (comparative) and in Example 5 (comparative), there was no recycling from the PFR (5) to the dynamic mixer (1), but rather an increasing quantity of radical initiator was fed which made it possible to reduce the reaction temperatures, in particular in the CSTR (4), with the same polymer production: it should be noted that in Example 5 (comparative) the formation of waxes was halved compared with Example 1 (comparative) (329 g/h with a Q_{wax}/Qₚₒₗ ratio of 5.4 g/kg) and an increase in the weight average molecular mass (M_{w}) was obtained, which is equal to 288 kDa;
in Example 6 (disclosure), a recycling equal to 33.3% of the reaction mixture leaving the PFR (5) was inserted, in feeding to the dynamic mixer (1) (RR=0.5) and it was thus possible to maintain the flow rate of the polymer produced by decreasing the reaction temperatures, especially in the CSTR (4), observing a decrease in the formation of waxes (235 g/h with a Q_{wax}/Qₚₒₗ ratio of 3.9 g/kg) and an increase in the weight average molecular mass (M_{w}) which is equal to 291 kDa;
in Example 7 (disclosure), in which a recycling ratio (RR) equal to 0.5 was maintained as in Example 6 (disclosure) and the flow rate of radical initiator was increased, a further decrease in the formation of waxes was obtained (182 g/h with a Q_{wax}/Qₚₒₗ ratio of 3.0 g/kg) and a further increase in the weight average molecular mass (M_{w}) which is equal to 300 kDa.

1. A continuous mass polymerisation process for the preparation of vinyl aromatic polymers comprising:
continuously feeding at least one vinyl aromatic monomer and at least one radical initiator to a mixing device, obtaining a reaction mixture;
feeding said reaction mixture to a Continuous Stirred Tank Reactor (CSTR), said Continuous Stirred Tank Reactor (CSTR) containing a polymer fraction, in the reaction mixture in liquid phase, between 45% by mass and 60% by mass, with respect to the total mass of said reaction mixture in liquid phase;
feeding the reaction mixture in liquid phase leaving said Continuous Stirred Tank Reactor (CSTR) to at least one Plug Flow Reactor (PFR), said at least one Plug Flow Reactor (PFR) containing a polymer fraction, in the reaction mixture in liquid phase leaving said at least one Plug Flow Reactor (PFR), of at least 65% by mass, with respect to the total mass of said reaction mixture in liquid phase leaving said at least one Plug Flow Reactor (PFR);
recycling, to said mixing device, a fraction of the reaction mixture in liquid phase leaving said at least one Plug Flow Reactor (PFR), said fraction being between 25% by mass and 50% by mass, with respect to the total mass of the reaction mixture in the liquid phase leaving said at least one Plug Flow Reactor (PFR);
feeding the remaining fraction of the reaction mixture in the liquid phase leaving said at least one Plug Flow Reactor (PFR), to a devolatilisation system;
optionally, feeding the polymer leaving said devolatilisation system to an additive system; and
feeding the polymer leaving said devolatilisation system or leaving said additive system, to a granulation system and recovering the polymer.

2. The continuous mass polymerisation process for the preparation of vinyl aromatic polymers according to claim 1, wherein said vinyl aromatic monomer is selected from vinyl aromatic monomers having general formula (I): 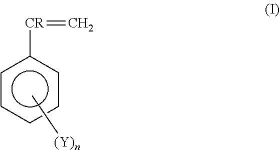
wherein R is a hydrogen atom or a methyl group, n is zero or 1, Y is a halogen atom such as chlorine, bromine, or a hydroxyl, or a halogenated alkyl group with 1 to 2 carbon atoms such as chloromethyl, bromomethyl, 1-bromoethyl, 1-chloroethyl, or an alkyl or alkoxy group with 1 to 2 carbon atoms.

3. The continuous mass polymerisation process for the preparation of vinyl aromatic polymers according to claim 1, wherein said vinyl aromatic monomer having general formula (I) is selected from: styrene, α-methylstyrene, isomers of vinyltoluene, isomers of ethylstyrene, isomers of bromine styrene, isomers of chlorine styrene, isomers of methylbromostyrene, isomers of methylchlorostyrene, isomers of 1-bromoethylstyrene, isomers of 1-chloroethylstyrene, isomers of methoxystyrene, isomers of acetoxystyrene, isomers of hydroxystyrene, isomers of methylhydroxystyrene, or mixtures thereof.

4. The continuous mass polymerization process for the preparation of a vinyl aromatic polymer according to claim 1, in which at least one comonomer is fed to said mixing device.

5. The continuous mass polymerization process for the preparation of a vinyl aromatic polymer according to claim 4, wherein said comonomer is selected from vinyl monomers such as C₄-C₈ alkyl esters deriving from (meth)acrylic acid, glycidyl(meth)acrylate, or mixtures thereof; divinyl monomers such as isomers of divinylbenzene, esters of (meth)acrylic acid with diols such as ethylene glycol-dimethacrylate, butanediol-diacrylate, butanediol-dimethacrylate, hexanediol-diacrylate, hexanediol-dimethacrylate, or mixtures thereof; or mixtures thereof.

6. The continuous mass polymerization process for the preparation of a vinyl aromatic polymer according to claim 1, in which said radical initiator is selected from the radical initiators having a half-life of 1 hour, determined by DSC (Differential Scanning calorimetry), in monochlorobenzene solvent, between 105° C. and 134° C., preferably difunctional radical initiators, such as: 1,1-di(tert-butylperoxy)-3,3,5-trimethylcyclohexane, 1,1-di(tert-amylperoxy)-cyclohexane, 1,1-di(tert-butilperoxy)-cyclohexane, tert-amylperoxy 2-ethylhexyl carbonate, tert-amylperoxyacetate, tert-butyl-peroxy-3,5,5-trimethylhexanoate, 2,2-di-tert-butyl-peroxybutane, tert-butylperoxy iso-propyl carbonate, tert-butylperoxy 2-ethylhexyl carbonate, tert-amyl peroxybenzoate, tert-butyl peroxyacetate, butyl-4,4-di(tert-butylperoxy)valerate, tert-butyl peroxybenzoate, di-tert-amyl peroxide, dicumyl peroxide, di(tert-butylperoxy-iso-propyl)benzene, 2,5-dimethyl-2,5-di(tert-butylperoxy)hexane, or mixtures thereof.

7. The continuous mass polymerization process for the preparation of a vinyl aromatic polymer according to claim 1, in which said radical initiator is present in the reaction mixture fed to said Continuous Stirred Tank Reactor (CSTR) to a concentration, calculated on the weight flow of the reaction mixture in liquid phase entering the devolatilisation system, of between 0.2 millimoles and 2.5 millimoles of peroxide groups —[OO]— per kg of reaction mixture in liquid phase.

8. The continuous mass polymerization process for the preparation of a vinyl aromatic polymer according to claim 1, in which at least one solvent is fed to said mixing device, said solvent being preferably selected from the group consisting of optionally substituted aromatic hydrocarbons such as ethylbenzene, xylene, n-propylbenzene, cumene, ethyltoluene, in an amount between 0% by weight and 20% by weight, with respect to the total weight of the reaction mixture.

9. The continuous mass polymerization process for the preparation of a vinyl aromatic polymer according to claim 1, wherein to said Continuous Stirred Tank Reactor (CSTR), or to said at least one Plug Flow Reactor (PFR), is fed at least one chain transfer.

10. The continuous mass polymerization process for the preparation of a vinyl aromatic polymer according to claim 9, wherein said chain transfer agent is selected from: low reactivity chain transfer agents such as 2,4-diphenyl-4-methyl-1-pentene (α-methylstyrene dimer), polyunsaturated organic substances of the hydrocarbon type such as vegetable oils, squalene, farnesene, limonene, terpinolene, or mixtures thereof; medium reactive chain transfer agents such as tertiary mercaptans with 4 to 12 carbon atoms, such as tert-butyl mercaptan, tert-dodecyl mercaptan, or mixtures thereof; high reactivity chain transfer agents such as primary mercaptans with 4 to 12 carbon atoms, such as n-butyl mercaptan, n-dodecyl mercaptan, or mixtures thereof.

11. The continuous mass polymerization process for the preparation of a vinyl aromatic polymer according to claim 1, in which, in said Continuous Stirred Tank Reactor (CSTR), the reaction temperature is between 120° C. and 140° C.

12. The continuous mass polymerization process for the preparation of a vinyl aromatic polymer according to claim 1, in which, in said at least one Plug Flow Reactor (PFR), the reaction temperature is between 130° C. and 175° C.
